(19) United States
(12) Patent Application Publication
(10) Pub. No.: US 2013/0210455 A1
(43) Pub. Date: Aug. 15, 2013

(54) AGGREGATING DEMOGRAPHIC DISTRIBUTION INFORMATION

(71) Applicants: Richard Carlsson, Stockholm (SE); George Kakhadze, Stockholm (SE); Szilvia Varga, Stockholm (SE); Hjalmar Olsson, Stockholm (SE); Simon Moritz, Stockholm (SE)

(72) Inventors: Richard Carlsson, Stockholm (SE); George Kakhadze, Stockholm (SE); Szilvia Varga, Stockholm (SE); Hjalmar Olsson, Stockholm (SE); Simon Moritz, Stockholm (SE)

(73) Assignee: TELEFONAKTIEBOLAGET L M ERICSSON (publ), Stockholm (SE)

(21) Appl. No.: 13/814,969

(22) PCT Filed: Aug. 10, 2010
(86) PCT No.: PCT/EP2010/061652

§ 371 Date: Apr. 22, 2013

(51) Int. Cl. H04W 24/08

(52) U.S. Cl. CPC H04W 24/08
USPC 455/456.1

(57) ABSTRACT

A method for aggregating demographic distribution information from a plurality of networks, the method comprising, in each network: monitoring the location of each of a plurality of user devices in each of a plurality of location areas; retrieving demographic information associated with a plurality of user devices; transmitting an indication of the demographic distribution for each location area to a data collector; the method further comprising: receiving the indications at the data collector and collating the information to generate an aggregated demographic distribution map.

### TECHNICAL FIELD

The present application relates to methods for aggregating demographic distribution information from a plurality of networks; a method of aggregating demographic distribution information; a network node; a service node; and a computer readable medium.

### BACKGROUND

Out-of-home (OOH) advertising comprises all types of advertising media that people are exposed to when not at home; such as billboards, advertisement on buses, street furniture advertisements, advertisements inside the cabins of public transport vehicles etc. The owners of OOH media need to measure the audience of their advertisements in order to be able to determine the value of their inventory and to determine where to place new media. The spending on OOH advertising in 2008 was around 29 billion USD and an estimated 145 million USD was spent by media owners on audience measurements.

Current audience measurements are taken manually by researchers visiting particular locations and counting people. These measurements are inherently costly to perform resulting in only limited data being available to media owners and advertisers.

There is a need for an improved way of measuring the audience of OOH media.

Of course, an accurate system for OOH audience measurement would also have applications in other fields, such as town planning or planning the provision of utilities, for example. Indeed, such information may even be used by wireless communication network operators to plan the development of their networks.

### SUMMARY

A mobile phone network generates and contains vast amounts of data about the subscribers that use the network. A mobile network operator has demographic information about where its subscribers live, what is their age and gender, how much they spend on mobile services, who they communicate with, etc. A mobile network operator can also derive location information about where its subscribers are and how they move about. This information can be used for a variety of different purposes. For example, information about how subscribers switch between radio base stations during their cell phone calls is used to estimate how fast traffic is moving on certain roads.

However, the information known to mobile network operators cannot easily be used for audience measurement for OOH media. One problem is the amount of data available is significant. A network can track each user device for all of the time it is broadcasting. At a sampling rate of every minute, with data considered over a week, this would result in over 10,000 location coordinates to process for one user device. A network with 1 million users will have 10 billion location coordinates to process for it to obtain the demographic variation of the distribution of its users over the course of a week.

An additional problem is that it is common for any particular geographical market to be fragmented between a plurality of different network operators. In order to obtain a statistically meaningful sample of the population, information from a plurality of network operators that serve a particular location must be combined.

To centrally accumulate demographic distribution information from each network would require a significant amount of data to be continuously sent from each network to the central accumulator, and significant processing resources would be required to perform any analysis of the data.

Further, in some jurisdictions data protection and/or privacy laws (e.g. UK Data Protection Act, 1998) mean that information about subscribers that can be traced to an individual cannot leave an operator's network. To store and aggregate information about individual subscribers in a system external to an operator's network would in many countries constitute a breach of the law.

Accordingly, there is provided a system which features a two-part aggregation process. In a first part of the aggregation, performed under the network operator's control, user demographic data and user location data is processed to produce processed demographic distribution information. The processed demographic distribution information gives an indication of the number of users in each demographic class identified as being within a particular area. This significantly reduces the volume of data while still retaining useful information about the demographic distribution of users. Further, the processed demographic distribution information is also anonymized, such that an individual user cannot be identified, allowing it to be sent out of the operators network for central accumulation.

In a second part of the aggregation, processed demographic distribution information from a plurality of networks is collected at a data collector, which is external to the networks. A further advantage of the reduced size data set is that this information is easier, quicker and/or less costly to transmit from the network. At the data collector, the processed demographic information from each of the plurality of networks is summed to provide a snap-shot demographic distribution map for the monitored areas.

Accordingly, there is provided a method for aggregating demographic distribution information from a plurality of networks. The method comprises, in each network: monitoring the location of each of a plurality of user devices in each of a plurality of location areas; retrieving demographic information associated with a plurality of user devices; and transmitting an indication of the demographic distribution for each location area to a data collector. The method further comprises, receiving the indications at the data collector and collating the information to generate an aggregated demographic distribution map.

There is also provided a method for aggregating demographic distribution information from a plurality of networks, the method comprising, in a network: monitoring the location of each of a plurality of user devices in each of a plurality of location areas; retrieving demographic information associated with a plurality of the user devices; and transmitting an indication of the demographic distribution for each location area.

The methods may further comprise assigning each of the plurality of user devices to at least one demographic class and summing the number of user devices of each demographic class present in each location area.

The monitoring of the location of each of a plurality of user devices may comprise: identifying an event associated with a user device; identifying a location area of the event; determining that the location area of the event exceeds a threshold change as compared to the location area of the last known event for the user device; and storing the location area of the event in association with the identity of the user device.

The transmitted indication may be suitable for a data collector. The data collector may be external to the network.

There is also provided a method of aggregating demographic distribution information, the method comprising, in a data collector: receiving an indication of the demographic distribution for each location area from a plurality of networks; and collating the received information to generate an aggregated demographic distribution map.

The method may further comprise sending report format instructions to a network. The report format instructions may define the personal information categories to be reported by the networks.

The indication of the demographic distribution for each location area may comprise at least one of: the number of user devices associated with each demographic class present in each location area; the change in the number of user devices associated with each demographic class present in each location area; and the movement in the number of user devices associated with each demographic class from one location area to another.

There is also provided a network node for collecting demographic and location data, the network node comprising: a location monitor arranged to monitor the location of each of a plurality of user devices in each of a plurality of location areas; a demographic database arranged to provide demographic information associated with a plurality of the user devices; and a reporting component arranged to prepare and transmit an indication of the demographic distribution for each location area.

The indication of the demographic distribution for each location area may be transmitted to a data collector. The data collector may be external to the network system.

There is also provided a service node for aggregating demographic location data, the service node comprising: a receiver arranged to receive an indication of the demographic distribution for each location area from a plurality of networks; and a processor arranged to collate the received information to generate an aggregated demographic distribution map.

The service node may be a data collector. The service node may further comprise a format coordinator arranged to send report format instructions to a network. The report format instructions define the personal information categories to be reported by the networks.

The personal information categories may comprise at least one of: age; sex; address; subscription package; income; social network characteristics; ethnicity; spoken languages; sexual preferences; religion; number of children; marital status; criminal background; biometric data; health data; insurance history; travel history; interests; hobbies; profession; web browsing history; phone call patterns; messaging pattern; number of contacts; education; sports habits; terminal/device information; location and transportation method.

There is also provided a computer-readable medium, carrying instructions, which, when executed by computer logic, causes said computer logic to carry out any of the above defined methods.

The disclosed method and apparatus allows combining information about subscribers' whereabouts and their personal information to create reports of the demographic distribution of individuals in different locations.

The disclosed method and apparatus allows the creation of reports of the demographic distribution of individuals in a geographical area while maintaining the privacy and integrity of the subscribers. This is possible because no information capable of being attributed to an individual user leaves the operator network.

Since the data collector can be placed outside the operator network it is possible to efficiently aggregate data from several operators so as to create a more accurate demographic profile (by including more individuals) than if only data from one operator were used.

The disclosed method may require collection of event information from the network and forwarding of this information to the data collector as they are received, allowing the data collector to keep an up-to-the-minute record of the demographic distribution of individuals in the monitored locations.

The demographic and location data obtained may be distributed to third parties without compromising the privacy of the individual.

### BRIEF DESCRIPTION OF THE DRAWINGS

A system and method for location based demographic profile aggregation will now be described, by way of example only, with reference to the accompanying drawings, in which:

FIG. 1 illustrates an example of a situation to which the present method may be applied;

FIG. 2 illustrates a system for performing the described method;

FIG. 3 shows an example arrangement of the disclosed system;

FIG. 4 shows the method performed in a network operator; and

FIG. 5 shows the method performed in a service provider.

### DETAILED DESCRIPTION

There is provided a two-part aggregation process for the accumulation of demographic distribution information. In a first part of the aggregation, performed under the network operator's control, user demographic data and user location data is processed to create processed demographic information. This is a summary of the demographic breakdown of users identified as being within each particular area of a monitored geographical region. This is substantially less data than the raw location and demographic data for each user. Further, the processed demographic information is also anonymized, such that an individual user cannot be identified. In a second part of the aggregation, processed demographic information from a plurality of networks is sent from each network and collected at a bulk location data collector, which is external to the networks. At the bulk location data collector the processed demographic information from each of the plurality of networks is summed to provide demographic distribution information for a sample of the population in each monitored area.

For each location area to which the system is applied, the processed demographic information comprises the numbers of user devices identified within the area at a given time and belonging to users of different demographic profiles. This may include the age profile of the users, such as the number of users less than 25, between 25 and 39, between 40 and 59, and over 60 years of age. This may also include the sex profile of the users (the number of men and the number of women). Further, this may include a more detailed breakdown between categories, such as the number of men less than 25, and the number of women between 25 and 39, etc.

The location area is typically defined by a cell; the network operator can identify which cell the user's device is communicating with and which geographical area the cell covers and thus determine the geographical area the user device is located in. A limitation of this method is that the cells in the network may not provide sufficient geographical resolution for some purposes. This can be addressed by installing a microcell or a picocell at a particular location with the purpose of making a connection only to user devices in the area of interest. User devices connected to the particular microcell or picocell may then be determined to be in the area of interest.

The data summary sent to the bulk location data collector may be in a predetermined format of particular demographic classes. Alternatively, the bulk location data collector instructs each network how to summarize the user location data and the user demographic data such that the different breakdowns of the data set available can be obtained for different purposes.

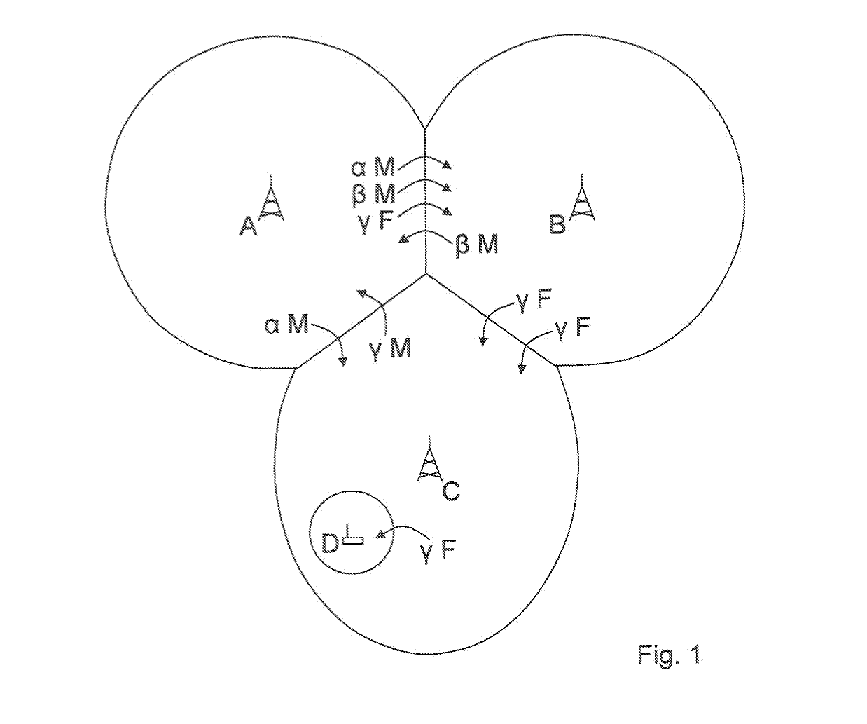

FIG. 1 illustrates an example of a situation to which the present method may be applied. FIG. 1 shows three adjoining cells, A, B and C, and a picocell D. The area served by picocell D is wholly within the area served by cell C. FIG. 1 also shows the movements of users between the cells over a particular time period (e.g. 1 minute). Each user is indicated as either male (M) or female (F). Further each user is indicated as a member of one of three demographic classes α, β, and γ. Demographic classes α, β, and γ could relate to age ranges such as less than 25, 25 to 50 and over 50 respectively, and in practice a greater number of subdivisions of the age range may be used.

In one embodiment, the summary data contains a record of the changes in demographic numbers from one area to another. This would be a net change in the numbers between cells, so if 2 α move from A to B and 1 α moves from B to A, the net change is 1 α from A to B. In the example of FIG. 1, a report for M/F and a report for α/β/γ would be created as follows:

| M/F | α/β/γ |
|---|---|
| 1 M from A to B | 1 α from A to B |
| 1 F from A to B | 1 γ from A to B |
| 2 F from B to C | 1 α from A to C |
| 1 F from C to D | 1 γ from C to A |
| | 2 γ from B to C |
| | 1 γ from C to D |

In an alternative embodiment, the summary contains the change in number of a demographic profile for each area. Considering again the example of FIG. 1, in this embodiment a report for M/F and a report for α/β/γ would be created as follows:

| M/F | α/β/γ |
|---|---|
| A: −1 M; −1 F | A: −2 α |
| B: +1 M; −1 F | B: +1 α; −1 γ |
| C: +1 F | C: +1 α |
| D: +1 F | D: +1 γ |

Information about events generated by subscribers' devices in different mobile networks is collected together with information about the subscribers (e.g. demographic data). This information is used to determine the change of the demographic distribution between different location areas. An event may be, for example: a device being switched on, a device initiating a call, a device initiating a data session, a device moving from one cell to another, or a response received from a device in response to polling by the network. In the case of polling, the network may request confirmation that the device is still present, and/or the location of the device, particularly if the device has a locating function such as a GPS receiver.

Once this information is collected, a summary reporting the change of the demographic distribution between different areas is reported to a system placed outside the operator network. In this way, after an initialization step where the total number of user devices associated with each demographic class in each location area is reported, the demographic profile at subsequent times can be determined by updating the initial values with the cumulative reported changes.

In either of the above examples, it is possible that a device will be turned off or deactivated such that its last known event was in a particular area, and no new event for that device is created allowing its location to be updated. In such a situation it is possible for the demographic details for the user of that device to be forever associated with a particular area even when the likelihood of the user still being in that area is remote. To overcome this problem, an aging method is used such that if no new event for a device is created within a location area within a particular time period (say, an hour, or ten minutes depending on expected event frequency for any given device) since the last known event, then the device and the associated user are assumed to have left the area.

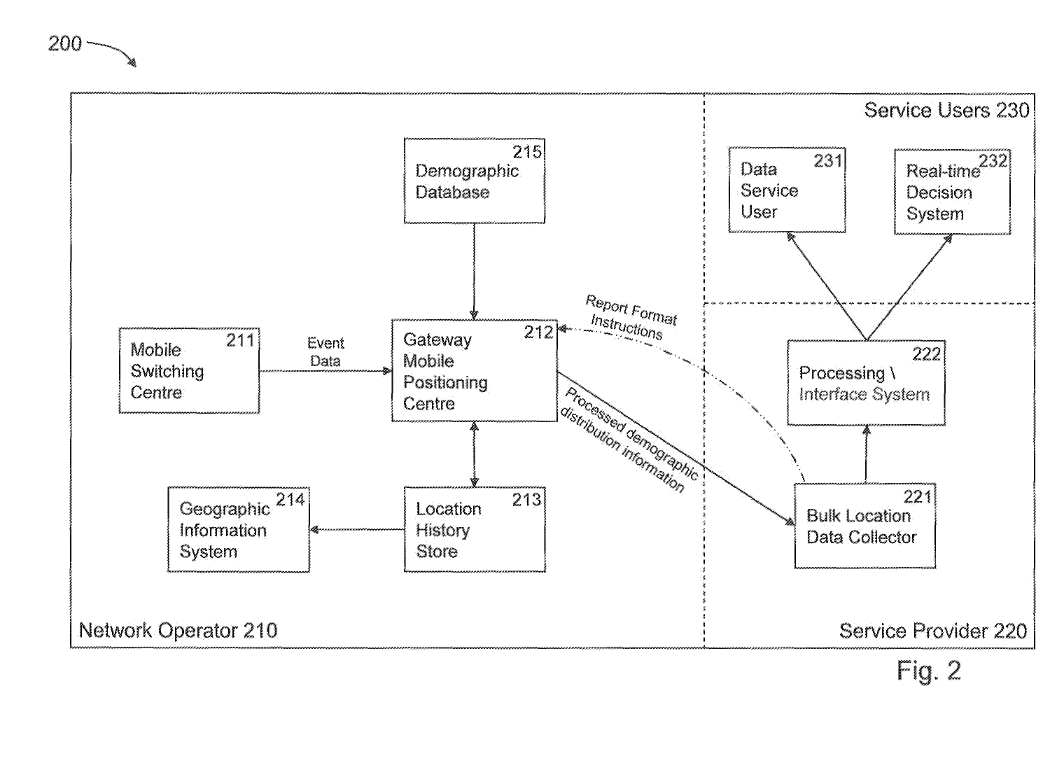

A system for performing the method described herein is illustrated in FIG. 2. The system is shown as split between a network operator system 210, a service provider system 220 and at least one service user system 230. The network operator system 210 comprises a system which is implemented in conjunction with the equipment of the operator's wireless communications network. The network operator system 210 comprises a mobile switching centre 211, a location history store 213 and a demographic database 215 all in communication with a Gateway Mobile Positioning Centre (GMPC) 212. The network operator system 210 also comprises a geographical information system 214 which is interrogated by the location history store 213. The service provider system 220 comprises a bulk location data collector 221 which receives information from GMPC 212, and a Processing/Interface system 222 which communicates with the service user systems 230. Service user systems 230 are shown by way of example as a data service user 231 and a real-time decision system 232.

In operation, the mobile switching centre 211 monitors a plurality of user devices and reports event data for events associated with each device to the GMPC 212. The event data comprises a unique identifier of the device and location information about where in the network the event took place. The location information may comprise the identity of the cell area in which the event took place. The GMPC 212 passes the event data to the location history store 213. The location history store 213 contains information about where the last event for each device occurred, and is updated when a new event for a device is identified. The location history store 213 stores the network information or translates the network information into a geographical position. The network information may comprise cell-id, timing advance value, or cell neighbor list, etc. The network information may be translated into a geographical position by looking up the location of the cell in a geographical information system 214, combining information from several cells, or using other information from the generated event, for example.

Every time an event is identified a comparison is made between the location of the new event and the last known location of the subscriber. If the distance between these two locations is greater than a pre-defined threshold, then the system determines that a movement has taken place. Referring to the embodiment of FIG. 1, a movement there is determined to have taken place if a device moves from one cell area to another. When a device movement is identified, the GMPC 212 looks up the personal details of the subscriber associated with that device in the demographic database 215. The personal details could be any information that is held by the network operator 210 that are interesting to aggregate and geographically map over time. Examples of such personal details are demographic information such as the age and gender of the subscriber.

The GMPC 212 processes the location information and the personal information to create processed location demographic information which is sent to the bulk location data collector 221. The processed location demographic information is thus sent from the network operator 210 to the service provider 220.

The bulk location data collector 221 sends report format instructions to the GMPC 212. The report format instructions define how the GMPC 212 should process the event information and personal information for transmittal to the bulk location data collector 221. The report format instructions may define the personal details that should be collected and the format in which they should be reported.

For example, the report format instructions may define how a particular category of personal details should be classified, such as:
the intervals for age range classification (less than 15, 15-19, 20-24 etc; or less than 15, 15 to 24, 25 to 34 etc); or
the level of detail of address information (such as the number of digits of a postal or ZIP code);

The report format instructions may define location areas for the network operator 210 to monitor. This is particularly useful where the service provider 220 receives processed location demographic information from a plurality of network operators covering the same physical area, but for which the cell areas of each network operator do not coincide.

Further, the report format instructions may define a sampling interval for how frequently the network operator 210 should report events to the service provider 220. For example, the service provider 220 may wish to receive notice of each event as it happens. Alternatively, the service provider 220 may require the network operator 210 to collate events over a particular time interval, say, every 3 minutes, and report the net changes over that period of time in the demographic profile for each location area. The instructions may also define when reports are to be delivered such that information received is in synch and can be easily combined.

The bulk location data collector 221 aggregates the received processed demographic distribution information and creates an aggregated demographic distribution map for a particular time. For example, this could give the distribution of male and females within a plurality of location areas of a given geographical area at the particular point in time. The bulk location data collector 221 stores each time indexed demographic distribution map to allow subsequent analysis of, for example, the variation in demographic distribution in an area over the course of a day.

Processing/Interface system 222 is provided to access the time indexed demographic distribution maps stored in the bulk location data collector 221. The processing/interface system 222 may generate and deliver particular reports of demographic distribution information to a data service user 231. Further, the processing/interface system 222 may deliver real-time reports of demographic distribution to a real-time decision system 232. Processing/Interface system 222 interfaces with external systems through a standardized API or simply using a network report.

The bulk location data collector 221 collects data over time such that the system builds up a store of data, recording how the demographic distribution of location areas varies over time. This enables the system to answer detailed questions about differences in movement patterns over months, seasons, years etc.

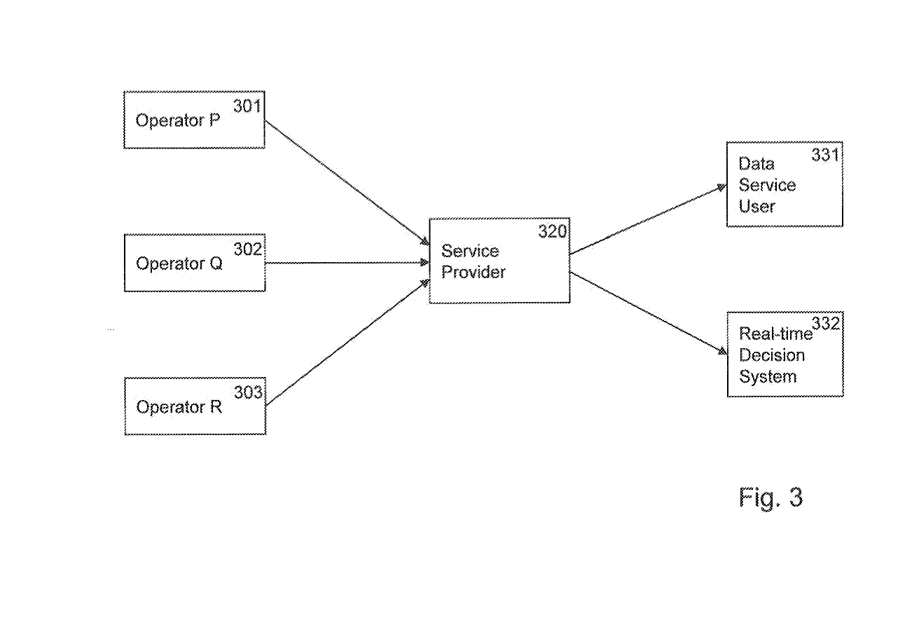

FIG. 3 shows an example arrangement of the disclosed system where three network operators 301, 302, 303 send indications of the demographic distribution for a plurality of areas within a particular geographical region to a service provider 320. A bulk location data collector in service provider 320 communicates with a GMPC in each network operator to coordinate the data it receives from each network such that it may be efficiently aggregated to generate an aggregated demographic distribution map for each location area within the geographical region. The aggregated demographic distribution map takes into account the device events for the devices communicating with any of the three operator networks. This information is reported to a data service user 331 and a real-time decision system 332.

The described method allows a system to aggregate information about the demographic distribution of people in different geographical areas. Since the service provider system 320 uses no personally identifiable data it can be placed outside the network of a mobile network operator and thus may aggregate information from multiple network operators 301, 302, 303 to create an accurate profile of the demographic distribution of individuals in different locations. It also makes it possible to deliver real-time data to other systems that can use it for making decisions based on the distribution of individuals in different locations.

Some OOH media consists of digital screens which display content such as advertisements. Digital screens have an advantage that the media owners can remotely change and adapt the content that is displayed through digital content distribution networks. These digital screens may be controlled by a real-time decision system 232, 332. Accordingly, a digital screen can be controlled so as to display content best suited to the demographic distribution of individuals identified in the location area of the digital screen. In this way, content can be chosen to target the specific demographic group currently present nearby the display.

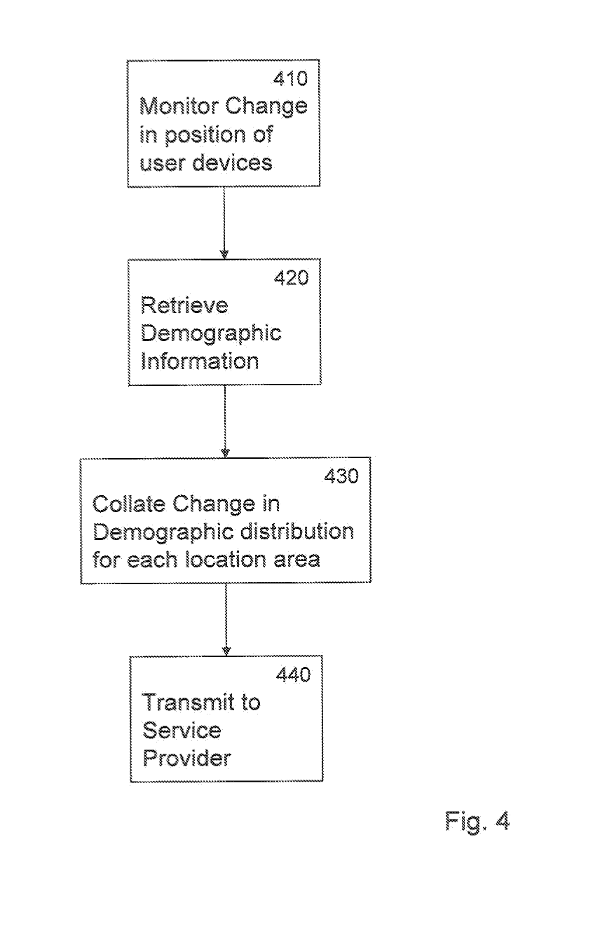

FIG. 4 shows the method performed in a network operator. The network operator system monitors 410 for changes in the position of user devices connected to its network. For every change identified, subject to any location change threshold, demographic information is retrieved 420 relating to a subscriber associated with the device for which a change is identified. This information is collated 430 to define the change in the demographic profile for each area. This collated information is then transmitted 440 to the service provider.

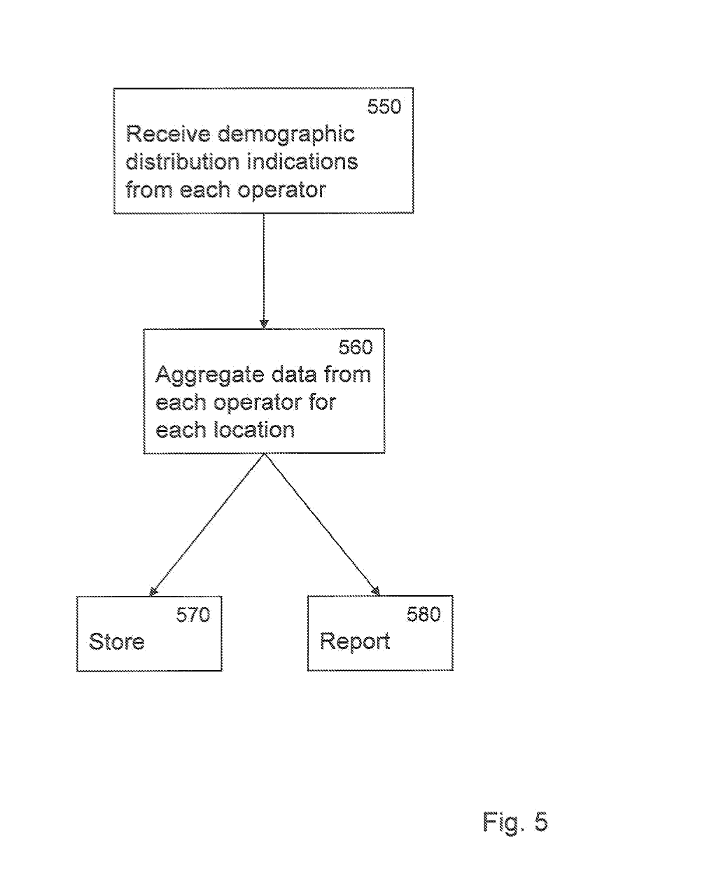

FIG. 5 shows the method performed in a service provider. The service provider system receives 550 an indication of the demographic distribution for each location area from each operator. This information is aggregated 560 by the service provider to generate a time indexed demographic distribution map which is stored 570 for future retrieval and analysis, and/or reported 580 to another system such as a service user.

In the above, an example is described where the location area is typically defined by a cell and the location data is derived from which cell area the device is in. In an alternative, the location data could be derived from any suitable source. For example, any wireless communications protocol such as Bluetooth, WiFi, etc. and by any means, such as triangulation or by direct reporting of location coordinates derived by a device having a locating function such as a GPS receiver and reported over a wireless communications link. The described system relates to any means for getting device location information to the operator. Further, it should be noted that these technologies could be used in conjunction with the described cell based system to provide more accurate location data when or where needed.

According to the above method and apparatus, the aggregation of demographic and location data is separated between the operator and the service provider. This allows:
Less data needs to be transferred from the operator to the service provider (less bandwidth used) as compared to known systems;
Enhanced user privacy by keeping sensitive information within a respective operator system;
Increased security, if the security of the service provider system is compromised by a malicious party, they could not use the data there to track or identify individuals;
Compliance with particular privacy or data protection laws which may be present in the relevant jurisdiction.

This document refers to demographic information of various types. It should be noted that in the context of this document the term “demographic” is used to refer to the statistical study of human populations especially with reference to size and density, distribution, and vital statistics. Merely by way of example, demographic information or demographic classes may comprise categories defining a person's: age; sex; address; subscription package; income; social network characteristics; ethnicity; spoken languages; sexual preferences; religion; number of children; marital status; criminal background; biometric data; health data; insurance history; travel history; interests; hobbies; profession; web browsing history; phone call patterns; messaging pattern; number of contacts; education; sports habits; terminal/device information; location; or transportation method. This list of examples is not exclusive.

It will be apparent to the skilled person that the exact order and content of the actions carried out in the method described herein may be altered according to the requirements of a particular set of execution parameters, such as speed, accuracy, information resolution, statistical processing to be applied, and the like. Accordingly, the order in which actions are described is not to be construed as a strict limitation on order in which actions are to be performed.

1. A method for aggregating demographic distribution information from a plurality of networks, the method comprising, in each network:
monitoring the location of each of a plurality of user devices in each of a plurality of location areas;
retrieving demographic information associated with a plurality of user devices;
transmitting an indication of the demographic distribution for each location area to a data collector;
the method further comprising:
receiving the indications at the data collector and collating the information to generate an aggregated demographic distribution map.

2. A method for aggregating demographic distribution information from a plurality of networks, the method comprising, in a network:
monitoring the location of each of a plurality of user devices in each of a plurality of location areas;
retrieving demographic information associated with a plurality of the user devices; and
transmitting an indication of the demographic distribution for each location area.

3. The method of claim 1, further comprising assigning each of the plurality of user devices to at least one demographic class and summing the number of user devices of each demographic class present in each location area.

4. The method of claim 1, wherein the monitoring of the location of each of a plurality of user devices comprises:
identifying an event associated with a user device;
identifying a location area of the event;
determining that the location area of the event exceeds a threshold change as compared to the location area of the last known event for the user device; and
storing the location area of the event in association with the identity of the user device.

5. The method of claim 1, wherein the transmitted indication is suitable for a data collector.

6. The method of claim 1, wherein the data collector is external to the network.

7. A method of aggregating demographic distribution information, the method comprising, in a data collector:
receiving an indication of the demographic distribution for each location area from a plurality of networks; and
collating the received information to generate an aggregated demographic distribution map.

8. The method of claim 7, further comprising sending report format instructions to a network.

9. The method according to claim 8, wherein the report format instructions define the personal information categories to be reported by the networks.

10. The method according to claim 8, wherein the personal information categories comprise at least one of:
age; sex; address; subscription package; income; social network characteristics; ethnicity; spoken languages; sexual preferences; religion; number of children; marital status; criminal background; biometric data; health data; insurance history; travel history; interests; hobbies; profession; web browsing history; phone call patterns; messaging pattern; number of contacts; education; sports habits; terminal/device information; location and transportation method.

11. The method of claim 1, wherein the indication of the demographic distribution for each location area comprises at least one of:
the number of user devices associated with each demographic class present in each location area;
the change in the number of user devices associated with each demographic class present in each location area; and
the movement in the number of user devices associated with each demographic class from one location area to another.

12. A network node for collecting demographic and location data, the network node comprising:
a location monitor arranged to monitor the location of each of a plurality of user devices in each of a plurality of location areas;
a demographic database arranged to provide demographic information associated with a plurality of the user devices; and
a reporting component arranged to prepare and transmit an indication of the demographic distribution for each location area.

13. A network node according to claim 12, wherein the indication of the demographic distribution for each location area is transmitted to a data collector.

14. A network node according to claim 12, wherein the data collector is external to the network system.

15. A service node for aggregating demographic location data, the service node comprising:
a receiver arranged to receive an indication of the demographic distribution for each location area from a plurality of networks; and
a processor arranged to collate the received information to generate an aggregated demographic distribution map.

16. A service node according to claim 15, wherein the service node is a data collector.

17. A service node according to claim 15, wherein the service node further comprises a format coordinator arranged to send report format instructions to a network.

18. A service node according to claim 17, wherein the report format instructions define the personal information categories to be reported by the networks.

19. A service node according to claim 18, wherein the personal information categories comprise at least one of:
age; sex; address; subscription package; income; social network characteristics; ethnicity; spoken languages; sexual preferences; religion; number of children; marital status; criminal background; biometric data; health data; insurance history; travel history; interests; hobbies; profession; web browsing history; phone call patterns; messaging pattern; number of contacts; education; sports habits; terminal/device information; location and transportation method.

20. A computer-readable medium, carrying instructions, which, when executed by computer logic, causes said computer logic to carry out any of the methods defined by claim 1.
